(19) United States
(12) Patent Application Publication
(10) Pub. No.: US 2016/0249262 A1
(43) Pub. Date: Aug. 25, 2016

(54) WIRELESS COMMUNICATION APPARATUS AND WIRELESS COMMUNICATION METHOD

(71) Applicant: KYOCERA CORPORATION, Kyoto (JP)

(72) Inventor: Akira HIRAO, Yokohama-shi (JP)

(73) Assignee: Kyocera Corporation

(21) Appl. No.: 15/052,748

(22) Filed: Feb. 24, 2016

(30) Foreign Application Priority Data
Feb. 25, 2015 (JP) 2015-035204

(51) Int. Cl. H04W 36/14; H04W 36/18; H04W 48/18

(52) U.S. Cl. CPC H04W 36/14; H04W 48/18; H04W 36/18

(57) ABSTRACT

A wireless communication apparatus and a wireless communication method are disclosed. At least one processor performs a reception processing of intermittently executing, while executing a first processing, a second processing in place of the first processing. The at least one processor has, as operation modes, a first operation mode and a second operation mode. In the first operation mode, the at least one processor stops executing the first processing and executes a search processing of searching for a signal transmitted in accordance with the second wireless communication scheme in a case where the at least one processor fails to acquire the second data in the reception processing. In the second operation mode, the at least one processor continues the reception processing without executing the search processing in a case where the at least one processor fails to acquire the second data in the reception processing.

### CROSS-REFERENCE TO RELATED APPLICATION

The present application claims priority under 35 U.S.C. §119 to Japanese Patent Application No. 2015-035204, filed on Feb. 25, 2015, entitled “WIRELESS COMMUNICATION APPARATUS AND OPERATING METHOD OF WIRELESS COMMUNICATION APPARATUS.” The content of which is incorporated by reference herein in its entirety.

### FIELD

Embodiments of the present disclose relate to wireless communication technology.

### BACKGROUND

Various techniques concerning wireless communication have been proposed.

### SUMMARY

A wireless communication apparatus and a wireless communication method are disclosed. In one embodiment, a wireless communication apparatus performs communication in accordance with a first wireless communication scheme and communication in accordance with a second wireless communication scheme. The wireless communication apparatus comprises a first antenna and at least one processor that executes a first processing of acquiring first data included in a first reception signal received by the first antenna and a second processing of acquiring second data included in the first reception signal. The first data is transmitted in accordance with the first wireless communication scheme. The second data is transmitted in accordance with the second wireless communication scheme. The at least one processor performs a reception processing of intermittently executing, while executing the first processing, the second processing in place of the first processing. The at least one processor has, as operation modes, a first operation mode and a second operation mode. The first operation mode is an operation mode in which the at least one processor stops executing the first processing and executes a search processing of searching for a signal transmitted in accordance with the second wireless communication scheme in a case where the at least one processor fails to acquire the second data in the reception processing. The second operation mode is an operation mode in which the at least one processor continues the reception processing without executing the search processing in a case where the at least one processor fails to acquire the second data in the reception processing.

In one embodiment, a wireless communication method comprises: stopping a first processing and executing a search processing of searching for a signal transmitted in accordance with a second wireless communication scheme in a case where a reception processing fails to acquire second data; and continuing the reception processing without executing the search processing in a case where the reception processing fails to acquire the second data. The reception processing intermittently executes, while executing the first processing, a second processing in place of the first processing. The first processing acquires first data that is included in a reception signal transmitted in accordance with a first wireless communication scheme. The second processing acquires the second data that is included in the reception signal and is transmitted in accordance with the second wireless communication scheme.

### BRIEF DESCRIPTION OF THE DRAWINGS

FIG. 1 illustrates a configuration of a wireless communication system.

FIG. 2 illustrates a configuration of a wireless communication apparatus.

FIG. 3 illustrates a configuration of a controller.

FIG. 4 illustrates an intermittent reception processing (low).

FIG. 5 illustrates an intermittent reception processing (high).

FIG. 6 illustrates a first operation.

FIG. 7 illustrates the first operation.

FIG. 8 illustrates a second operation.

FIG. 9 illustrates the second operation.

FIG. 10 illustrates an example of a selection screen.

FIG. 11 illustrates a flowchart showing an operation of the wireless communication apparatus.

FIG. 12 illustrates an example of a designation screen.

FIG. 13 illustrates a flowchart showing an operation of the wireless communication apparatus.

### DETAILED DESCRIPTION

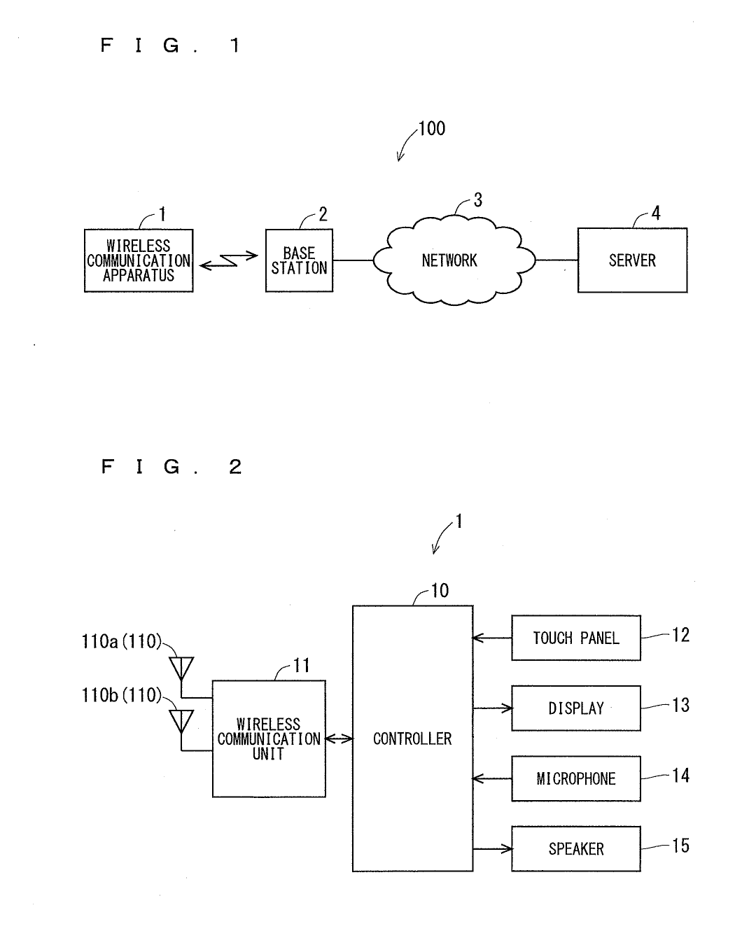

FIG. 1 illustrates a configuration of a wireless communication system 100 including a wireless communication apparatus 1 according to one embodiment. The wireless communication apparatus 1 according to one embodiment is, for example, a mobile phone, such as a smartphone. As illustrated in FIG. 1 the wireless communication apparatus 1 can perform wireless communication with a base station 2. The base station 2 is connected to a network 3, such as the Internet. Through the base station 2 and the network 3, the wireless communication apparatus 1 can communicate with a server apparatus 4 and the like connected to the network 3.

The wireless communication apparatus 1 can perform communication in accordance with a plurality of types of wireless communication schemes. The wireless communication schemes can be also referred to as wireless communication technologies. The wireless communication apparatus 1 complies with, for example, single radio Long Term Evolution (SRLTE) and can perform communication in accordance with LTE and communication in accordance with Code Division Multiple Access (CDMA) 2000 1×. Hereinafter, CDMA2000 1× is also simply referred to as “1×.” Communication performed in accordance with LTE is also referred to as “LTE communication,” and communication in accordance with 1× is also referred to as “1× communication.”

Although only a single base station 2 is illustrated in FIG. 1, the base station 2 may comprise a base station 2 capable of performing both LTE communication and 1×communication, a base station 2 capable of performing only LTE communication, and a base station 2 capable of performing only 1× communication. The wireless communication apparatus 1 can communicate with these three types of base stations 2.

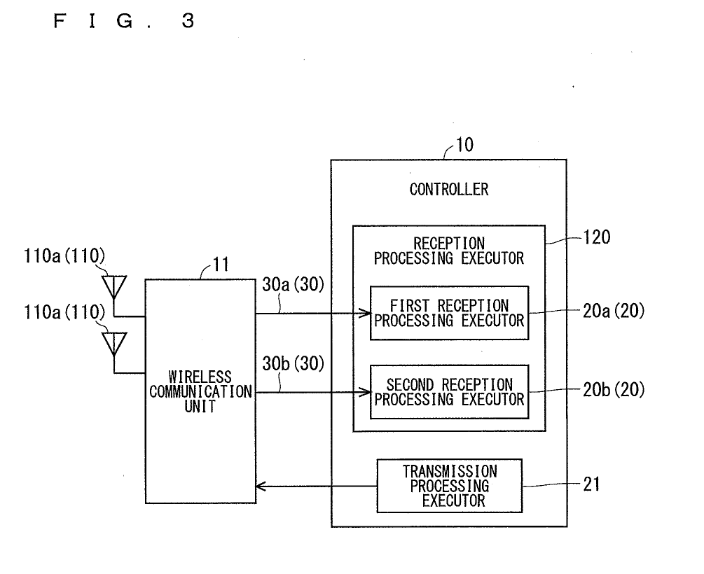

FIG. 2 illustrates a configuration of the wireless communication apparatus 1. As illustrated in FIG. 2, the wireless communication apparatus 1 includes a controller 10, a wireless communication unit 11, a touch panel 12, a display 13, a microphone 14, and a speaker 15.

The controller 10 can perform overall control over the wireless communication apparatus 1 by controlling other components of the wireless communication apparatus 1. The controller 10 is a kind of digital processing circuitry, and includes a central processing unit (CPU), a digital signal processor (DSP), a storage, and various digital circuits. The storage of the controller 10 includes read-only memory (ROM) and random-access memory (RAM), and the like. Various functions of the controller 10 may be implemented by the CPU and the DSP executing various programs in the storage.

The wireless communication unit 11 includes a plurality of antennas. In one embodiment, the wireless communication unit 11 includes, for example, two antennas, namely antennas 110a and 110b. The wireless communication unit 11 can perform wireless communication with the base station 2 using the antennas 110a and 110b. In one embodiment, the wireless communication apparatus 1 can perform reception processing using the antennas 110a and 110b. Meanwhile, the wireless communication apparatus 1 can perform transmission processing using one of the antennas 110a and 110b.

The wireless communication unit 11 can perform, for example, an amplification processing and a down conversion on a plurality of reception signals received by the antennas 110a and 110b, and accordingly generate baseband reception signals in the analog format. The wireless communication unit 11 can then convert the generated baseband signals in the analog format into baseband reception signals in the digital format, and output the baseband reception signals to the controller 10. The controller 10 can perform various types of digital signal processing on each of the baseband reception signals input in the digital format, and accordingly acquire user data, control data, and the like included in the baseband reception signals.

The wireless communication unit 11 can convert the baseband transmission signals in the digital format generated by the controller 10 and including user data, control data, and the like into baseband transmission signals in the analog format. The wireless communication unit 11 can perform, for example, an up-conversion and an amplification processing on the generated baseband transmission signals in the analog format, and accordingly generate transmission signals in a carrier band. The wireless communication unit 11 can wirelessly transmit the generated transmission signals in the carrier band from one of the antennas 110a and 110b. Hereinafter, the antennas 110a and 110b are each referred to as an “antenna 110” unless there is a particular need to distinguish between them.

The display 13 includes, for example, a liquid crystal panel or an organic EL panel. The display 13 can display a variety of information including characteristics, signs, and figures through control by the controller 10. The touch panel 12 is, for example, a projected capacitive touch panel. The touch panel 12 can detect an operation performed on a display surface of the display 13 with an operator, such as a finger. When a user performs an operation on the display surface of the display 13 with the operator, such as the finger, an electrical signal corresponding to the operation is input through the touch panel 12 to the controller 10. The controller 10 can specify the details of the operation performed on the display surface of the display 13 based on the electrical signal input through the touch panel 12, and perform processing in accordance with the details.

The microphone 14 can convert sound input from the outside of the wireless communication apparatus 1 into electrical sound signals, and output the electrical sound signals to the controller 10. The speaker 15 can convert electrical sound signals from the controller 10 into sound, and output the sound to the outside of the wireless communication apparatus 1.

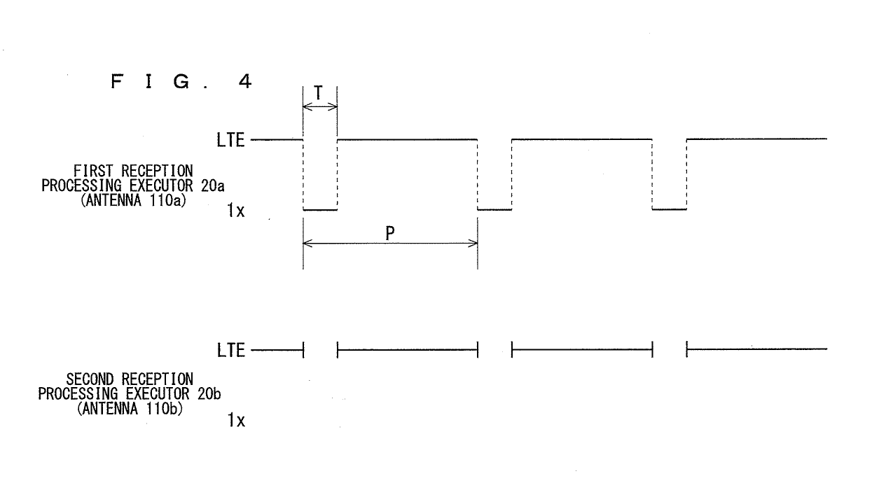

FIG. 3 illustrates a configuration of part of the controller 10. As illustrated in FIG. 3, the controller 10 includes a reception processing executor 120 and a transmission processing executor 21 as functional blocks. The reception processing executor 120 includes a first reception processing executor 20a and a second reception processing executor 20b.

As described above, the wireless communication unit 11 can convert reception signals received by the antenna 110a into baseband reception signals in the digital format. The baseband reception signals are referred to as “reception signals 30a.” The wireless communication unit 11 can also convert reception signals received by the antenna 110b into baseband reception signals in the digital format. The baseband receptions signals are also referred to as “reception signals 30b.”

The first reception processing executor 20a can perform various types of digital signal processing, such as demodulation, on the reception signals 30a output from the wireless communication unit 11, and acquire data, known signals, and the like included in the reception signals 30a. The second reception processing executor 20b can perform various types of digital signal processing, such as demodulation, on the reception signals 30b output from the wireless communication unit 11, and acquire data and known signals included in the reception signals 30b. The transmission processing executor 21 can generate baseband transmission signals including data and the like using various types of digital signal processing, such as modulation, and output the baseband transmission signals to the wireless communication unit 11.

Hereinafter, the first reception processing executor 20a and the second reception processing executor 20b are each referred to as a “reception processing executor 20” unless there is a particular need to distinguish between them. The reception signals 30a and 30b are each referred to as “reception signals 30” unless there is a particular need to distinguish between them.

The reception processing executors 20 can perform the processing of acquiring data that is included in reception signals received by the antennas 110 and is transmitted in accordance with LTE as well as the processing of acquiring data that is included in the reception signals and is transmitted in accordance with 1×. The former processing is referred to as “LTE reception processing,” and the latter processing is referred to as “1× reception processing.” The data transmitted in accordance with LTE is referred to as “LTE data,” and the data transmitted in accordance with 1× is referred to as “1× data.”

In the LTE reception processing, the reception processing executors 20 can perform the digital signal processing in accordance with LTE on the input reception signals 30, and accordingly acquire the LTE data included in the reception signals 30. The reception signals 30 including the LTE data are orthogonal frequency division multiplexing (OFDM) signals, and thus a discrete Fourier transform (DFT) and the like are performed on the reception signals 30 in the LTE reception processing.

In the 1× reception processing, the reception processing executor 20 performs the digital signal processing in accordance with 1× on the input reception signals 30, and accordingly acquire the 1× data included in the reception signals 30. The reception signals 30 including the 1× data have undergone spread spectrum, and thus multiplications of spreading codes (despreading processing) and the like are performed on the reception signals 30 in the 1× reception processing.

In one embodiment, the LTE reception processing is the processing of acquiring the LTE data included in the reception signals received by the antennas 110. That is, the LTE reception processing is the processing of performing the digital reception processing, such as demodulation, in accordance with LTE on the reception signals 30 in order to acquire the LTE data included in the reception signal 30. Thus, in a case where a transmission channel between the wireless communication apparatus 1 and the base station 2 capable of performing LTE communication is in a poor condition or in a case where the wireless communication apparatus 1 is out of the range of LTE communication, the reception processing executor 20 fails to receive the LTE data in some cases even if the reception processing executor 20 performs the LTE reception processing.

Similarly, the 1× reception processing is the processing of acquiring the 1× data included in the reception signals received by the antennas 110. That is, the 1× reception processing is the processing of performing the digital reception processing in accordance with 1× on the reception signals 30 in order to acquire the 1× data included in the reception signals 30. Thus, in a case where a transmission channel between the wireless communication apparatus 1 and the base station 2 capable of performing 1× communication is in a poor condition or in a case where the wireless communication apparatus 1 is out of the range of 1× communication, the reception processing executor 20 fails to acquire the 1× data in some cases even if the reception processing executor 20 performs the 1× reception processing.

In a case where the wireless communication apparatus 1 performs transmission in accordance with the LTE, the transmission processing executor 21 generates transmission signals (OFDM signals) in accordance with LTE by performing an inverse DFT (IDFT), and outputs the transmission signals to the wireless communication unit 11. In a case where the wireless communication apparatus 1 performs transmission in accordance with 1×, the transmission processing executor 21 generates transmission signals (spread spectrum signals) in accordance with 1×, and outputs the transmission signals to the wireless communication unit 11.

The wireless communication apparatus 1 having the above-mentioned configuration can perform data communication and voice communication. Specifically, the wireless communication apparatus 1 can perform, through the base station 2 and the network 3, data communication with the server apparatus 4 and the like connected to the network 3. The wireless communication apparatus 1 can also perform data communication with another mobile phone through the base station 2 and the network 3. Furthermore, the wireless communication apparatus 1 performs voice communication with another mobile phone through the base station 2 and the network 3 with the use of the microphone 14, the speaker 15, and the like. In the wireless communication system 100 according to one embodiment, data communication can be performed in accordance with both LTE and 1×. Meanwhile, voice communication can be performed in accordance with only 1× from among LTE and 1×. In a case where the base station 2 transmits signals using the multi-input multi-output (MIMO) scheme, the wireless communication apparatus 1 receives signals from the base station 2 using the antennas 110a and 110b. In a case where the wireless communication apparatus 1 is within the range of both LTE communication and 1× communication when performing data communication in the absence of incoming calls associated with voice communication, the wireless communication apparatus 1 performs communication in accordance with LTE.

### <Reception Processing Performed by Wireless Communication Apparatus>

In one embodiment, in a case where the wireless communication apparatus 1 does not perform voice communication and performs reception in accordance with LTE using the antennas 110a and 110b, the wireless communication apparatus 1 intermittently performs reception in accordance with 1× using one of the antennas 110 in order to receive an incoming call notification for providing notification of a call from another mobile phone in voice communication. In particular, in a case where the first reception processing executor 20a and the second reception processing executor 20b perform the LTE reception processing in the wireless communication apparatus 1, one of the reception processing executors 20 intermittently performs the 1× reception processing in place of the LTE reception processing. This processing is hereinafter referred to as “intermittent reception processing.” The intermittent reception processing will be described below in detail.

### <Details of Intermittent Reception Processing>

In one embodiment, the reception sensitivity of one of the antennas 110 is set to be higher than the reception sensitivity of the other antenna 110. The following description will be given assuming that, for example, the reception sensitivity of the antenna 110a is set to be higher than the sensitivity of the antenna 110b. The antennas 110a and 110b are hereinafter also referred to as a “high-sensitivity antenna 110a” and a “low-sensitivity antenna 110b.”

The base station 2 capable of communicating with the wireless communication apparatus 1 regularly transmits paging signals for voice communication. In a case where an incoming call to the wireless communication apparatus 1 in voice communication is issued, the base station 2 can transmit paging signals including data (hereinafter also referred to as “incoming call notification data”) that provides notification of the incoming call directed to the wireless communication apparatus 1. The wireless communication apparatus 1 is informed of the transmission cycle in which the base station 2 connected to the wireless communication apparatus 1 transmits paging signals. In the intermittent reception processing, one of the reception processing executors 20 intermittently performs the 1× reception processing in synchronism with the paging signal transmission cycle such that regularly transmitted paging signals undergo the reception processing. That is, in the intermittent reception processing, one of the reception processing executors 20 performs the 1× reception processing at the timing of paging signal transmission from the base station 2.

In the intermittent reception processing according to one embodiment, the 1× reception processing is performed by one or the other of the reception processing executors 20 depending on the received signal strength of a signal (hereinafter also referred to as a “1× signal”) transmitted in accordance with 1×. In particular, in a case where the received signal strength of the 1× signal is high, the second reception processing executor 20b that processes reception signals received by the low-sensitivity antenna 110b intermittently performs the 1× reception processing. In a case where the received signal strength of the 1× signal is low, meanwhile, the first reception processing executor 20a that processes reception signals received by the high-sensitivity antenna 110a intermittently performs the 1× reception processing. The intermittent reception processing performed in a case where the received signal strength of the 1× signal is high is hereinafter also referred to as an “intermittent reception processing (high).” The intermittent reception processing performed in a case where the received signal strength of the paging signal is low is hereinafter also referred to as an “intermittent reception processing (low).”

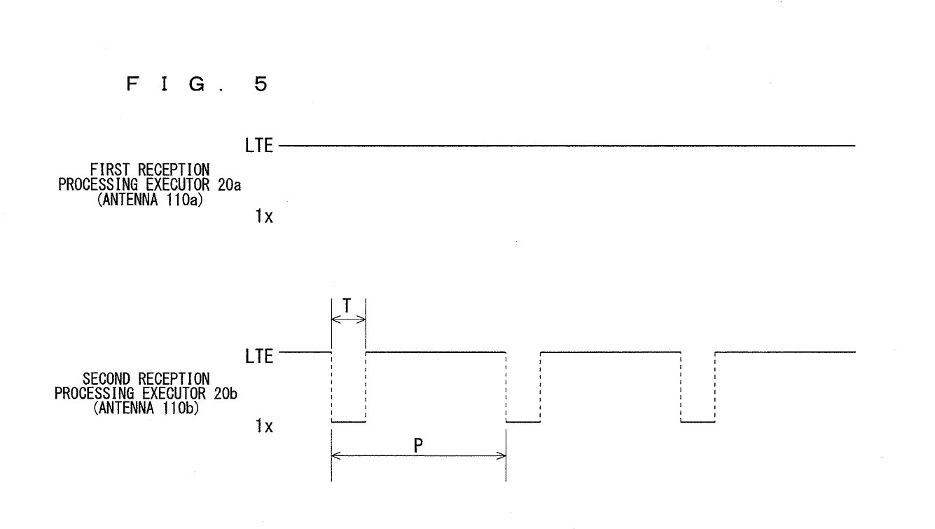

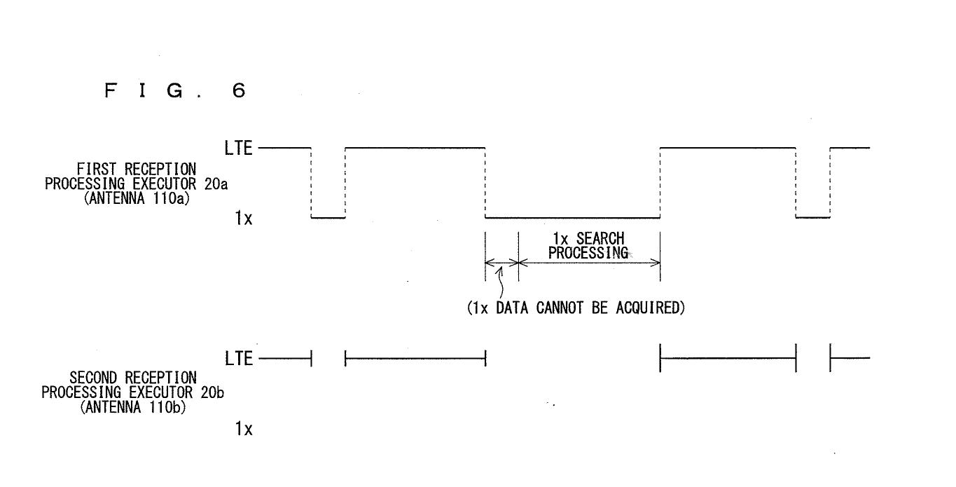

FIG. 4 illustrates the intermittent reception processing (low), and FIG. 5 illustrates the intermittent reception processing (high). With reference to FIGS. 4 and 5, the lateral solid lines indicate the time period during which the LTE reception processing is performed and the time period during which the 1× reception processing.

As illustrated in FIGS. 4 and 5, the LTE reception processing is basically performed by the respective reception processing executors 20 in the intermittent reception processing. As illustrated in FIG. 4, in the intermittent reception processing (low), the first reception processing executor 20a corresponding to the high-sensitivity antenna 110a intermittently performs, while performing the LTE reception processing, the 1× reception processing in place of the LTE reception processing. That is, the first reception processing executor 20a alternately performs the LTE reception processing and the 1× reception processing. Meanwhile, the second reception processing executor 20b corresponding to the low-sensitivity antenna 110b basically performs the LTE reception processing in a continuous manner, and does not perform neither the LTE reception processing nor the 1× reception processing only for a time period during which the first reception processing executor 20a performs the 1× reception processing. In the intermittent reception processing (low), the low-sensitivity antenna 110b is used only for the reception in accordance with LTE, and the high-sensitivity antenna 110a is used for both the reception in accordance with LTE and the reception in accordance with 1×.

In the intermittent reception processing (high), meanwhile, as illustrated in FIG. 5, the first reception processing executor 20a corresponding to the high-sensitivity antenna 110a continuously performs the LTE reception processing. The second reception processing executor 20b corresponding to the low-sensitivity antenna 110b intermittently performs, while performing the LTE reception processing, the 1× reception processing in place of the LTE reception processing. In the intermittent reception processing (high), the high-sensitivity antenna 110a is used only for the reception in accordance with LTE, and the low-sensitivity antenna 110b is used for both the reception in accordance with LTE and the reception in accordance with 1×.

The 1× reception processing in the intermittent reception processing is performed at execution intervals (execution cycle) P of, for example, several seconds. The 1× reception processing in the intermittent reception processing is performed for an execution period T of, for example, several tens of milliseconds.

In a case where the reception processing executor 20 that intermittently performs the 1× reception processing acquires, from the paging signals received by the antenna 110 corresponding to the relevant reception processing executor 20, incoming call notification data directed to the wireless communication apparatus 1 in the intermittent reception processing, the respective reception processing executors 20 suspend the LTE reception processing (the intermittent reception processing is ended), and accordingly the wireless communication apparatus 1 starts a series of incoming call processing by performing 1× communication through the use of both of the antennas 110a and 110b. When a series of incoming call processing is completed, the controller 10 controls the display 13 and the like to notify the user of an incoming call from another mobile phone. In a case where the user performs the response operation to respond to the incoming call from the other mobile phone by operating the display surface of the display 13, the wireless communication apparatus 1 enters the call state to perform voice communication. Meanwhile, in a case where the reception processing executor 20 that intermittently performs the 1× reception processing acquires, from the paging signals received by the antenna 110 corresponding to the relevant reception processing executor 20, incoming call notification data directed to a mobile phone other than the wireless communication apparatus 1, the reception processing executor 20 scraps the incoming call notification data.

In one embodiment, the reception processing executor 120 obtains, based on the reception signals 30 output from the wireless communication unit 11, the received signal strength of the 1× signal received by the antenna 110. If the received signal strength of the 1× signal is greater than the threshold, the reception processing executor 120 performs the intermittent reception processing (high). If the received signal strength of the 1× signal is equal to or smaller than the threshold, meanwhile, the reception processing executor 120 performs the intermittent reception processing (low). The reception processing executor 120 also obtains the received signal strength of the 1× signal while performing the intermittent reception processing. The reception processing executor 120 can switch from the intermittent reception processing (high) to the intermittent reception processing (low) and switch from the intermittent reception processing (low) to the intermittent reception processing (high) depending on the received signal strength of the 1× signal.

### <Search Processing on 1× Signal>

For example, in a case where the received signal strength of the 1× signal is very small or in a case where the transmission channel between the wireless communication apparatus 1 and the base station 2 connected therewith falls in deteriorated conditions, the wireless communication apparatus 1 that performs the intermittent reception processing may fail to detect paging signals. That is, in some cases, the reception processing executor 120 that performs the intermittent reception processing fails to acquire the 1× data, such as incoming call notification data, from the reception signals even if the reception processing executor 120 performs the 1× reception processing. In one embodiment, in a case where the reception processing executor 120 that performs the intermittent reception processing fails to acquire the 1× data (fails to detect the 1× signal) in the 1× reception processing, the reception processing executor 120 can perform a search processing (hereinafter referred to as a “1× search processing”) of searching for the 1× signal. The 1× search processing will be described below in detail.

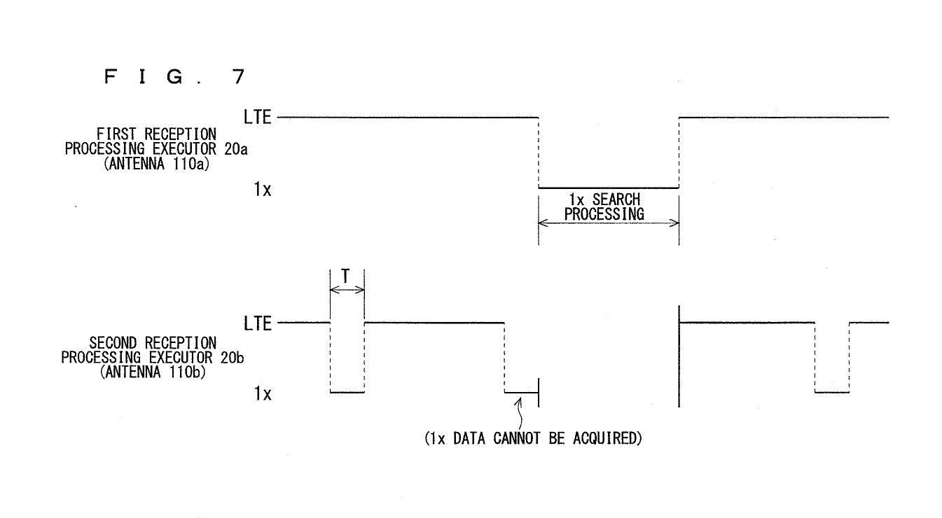

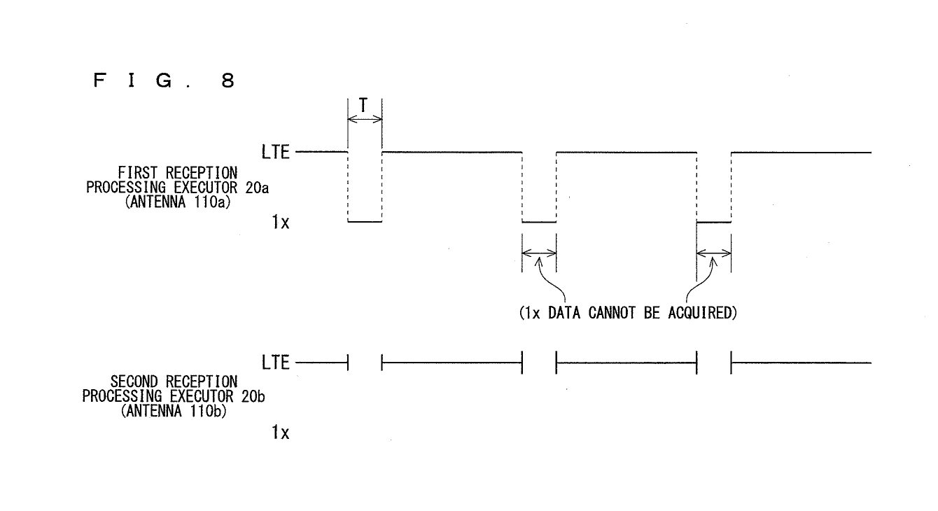

FIG. 6 illustrates the state in which the reception processing executor 120 performing the intermittent reception processing (low) performs the 1× search processing. FIG. 7 illustrates the state in which the reception processing executor 120 performing the intermittent reception processing (high) performs the 1× search processing.

As illustrated in FIGS. 6 and 7, the 1× search processing is always performed by the first reception processing executor 20a corresponding to the high-sensitivity antenna 110a in one embodiment. As illustrated in FIG. 6, in a case where the first reception processing executor 20a fails to acquire the 1× data in the 1× reception processing during the intermittent reception processing (low), the first reception processing executor 20a determines that it is unable to detect the 1× signal, and thus the first reception processing executor 20a performs the 1× search processing. In the 1× search processing, the reception processing executor 20 searches for the 1× signal by changing the frequency component of the signal received from the reception signals 30 or by changing the spreading codes used in the 1× reception processing. The 1× search processing is also described as a cell search in which the base station 2 that can be connected with the wireless communication apparatus 1 and performs 1× communication is searched.

While the first reception processing executor 20a performs the 1× search processing, the second reception processing executor 20b does not perform neither the LTE reception processing nor the 1× reception processing. When the first reception processing executor 20a detects the 1× signal in the 1× search processing and thus becomes capable of acquiring the 1× data, the reception processing executor 120 resumes the intermittent reception processing (low). In a case where the received signal strength of the 1× signal detected in the 1× search processing is greater than the threshold, the reception processing executor 120 executes, after the completion of the 1× search processing, the intermittent reception processing (high) instead of resuming the intermittent reception processing (low). If the base station 2 connected with the wireless communication apparatus 1 has been shifted to another base station 2 in the 1× search processing, there may be differences in the execution intervals P of the 1× reception processing and the execution period T of the 1× reception processing between before the start of the search processing and after the completion of the 1× search processing.

Meanwhile, as illustrated in FIG. 7, in a case where the second reception processing executor 20b that intermittently performs the 1× reception processing fails to detect the 1× signal and thus fails to acquire the 1× data in the 1× reception processing during the intermittent reception processing (high), the first reception processing executor 20a performs the 1× search processing. While the first reception processing executor 20a performs the 1× search processing, the second reception processing executor 20b does not perform neither the LTE reception processing nor the 1× reception processing. When the first reception processing executor 20a detects the 1× signal in the 1× search processing and thus becomes capable of acquiring the 1× data, the reception processing executor 120 resumes the intermittent reception processing (high). In a case where the received signal strength of the 1× signal detected in the 1× search processing is equal to or smaller than the threshold, the reception processing executor 120 executes, after the completion of the 1× search processing, the intermittent reception processing (low) instead of resuming the intermittent reception processing (high).

Thus, the first reception processing executor 20a does not perform the LTE reception processing while executing the 1× search processing. Furthermore, the second reception processing executor 20b does not perform the LTE reception processing while the first reception processing executor 20a executes the 1× search processing. The reception processing executor 120 is therefore unable to acquire the LTE data while executing the 1× search processing, causing deterioration of LTE communication.

In one embodiment, the reception processing executor 120 has, as operation modes, a first operation mode in which, in a case where the reception processing executor 120 fails to acquire the 1× data (fails to detect the 1× signal) in the intermittent reception processing, the reception processing executor 120 executes the 1× search processing as illustrated in the above-mentioned FIGS. 6 and 7 and a second operation mode in which, in a case where the reception processing executor 120 fails to acquire the 1× data in the intermittent reception processing, the reception processing executor 120 continues the intermittent reception processing without executing the 1× search processing. The reception processing executor 120 operates in the second operation mode, so that the reception processing executor 120 can acquire the LTE data in an appropriate manner, and accordingly the LTE communication performance improves.

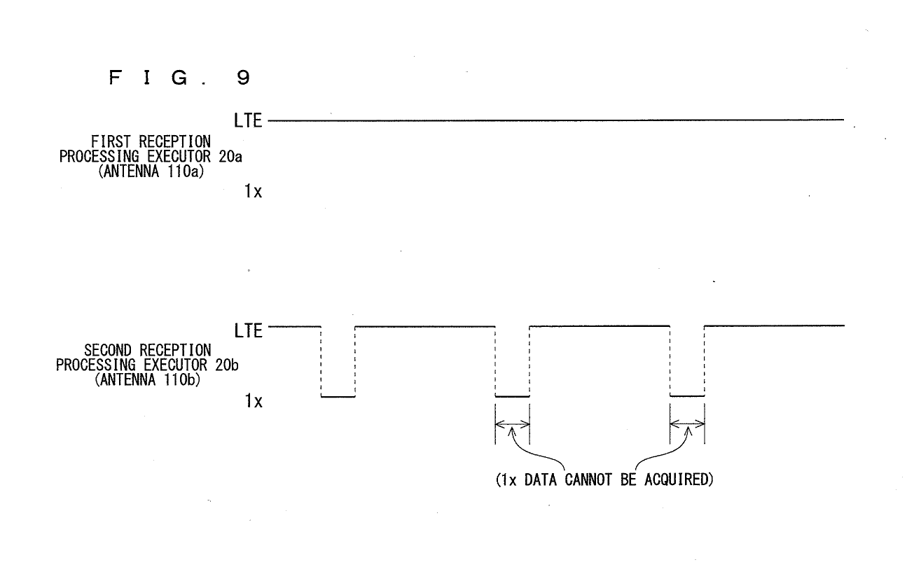

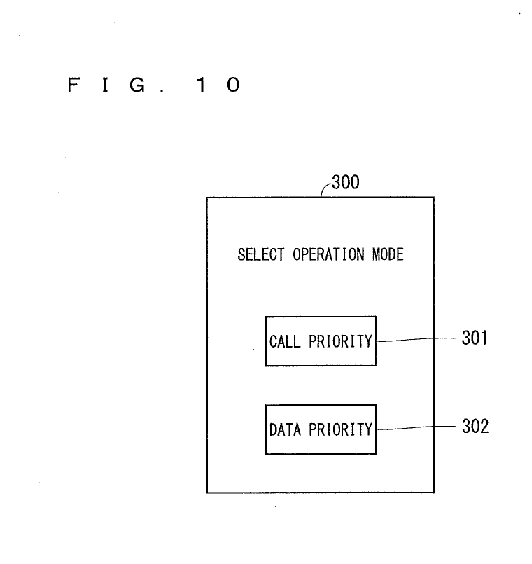

FIGS. 8 and 9 are provided to describe the second operation mode. FIG. 8 illustrates the second operation mode in which, in a case where the 1× data cannot be acquired in the intermittent reception processing (low), the intermittent reception processing (low) is continued with the 1× search processing not being executed. FIG. 9 illustrates the second operation mode in which, in a case where the 1× data cannot be acquired in the intermittent reception processing (high), the intermittent reception processing (high) is continued with the 1× search processing not being executed.

As illustrated in FIG. 8, in the second operation mode, even in a case where the first reception processing executor 20a fails to acquire the 1× data in the 1× reception processing during the intermittent reception processing (low), the 1× search processing is not executed and the intermittent reception processing (low) is maintained. As illustrated in FIG. 9, even in a case where the second reception processing executor 20b fails to acquire the 1× data in the 1× reception processing during the intermittent reception processing (high), the 1× search processing is not executed and the intermittent reception processing (high) is maintained.

Thus, in one embodiment, the reception processing executor 120 has, as operation modes, the first operation mode (FIGS. 6 and 7) in which the 1× search processing is executed and the second operation mode (FIGS. 8 and 9) in which the 1× search processing is not executed. The reception processing executor 120 operates in the second operation mode, and accordingly the reception processing executor 120 can acquire the LTE data in an appropriate manner. This produces an improvement in the data communication performance of the wireless communication apparatus 1.

In some cases, another mobile phone issues a call in voice communication to the wireless communication apparatus 1 while the reception processing executor 120 operates in the second operation mode, or equivalently, while the reception processing executor 120 fails to receive the 1× data (fails to detect the 1× signal) in the intermittent reception processing but continues the intermittent reception processing without executing the 1× search processing. In this case, the reception processing executor 120 terminates the second operation mode. After the reception processing executor 120 becomes capable of detecting the 1× signal, data (hereinafter referred to as “missed call data”) indicating a missed call is transmitted to the wireless communication apparatus 1 from the base station 2 connected with the wireless communication apparatus 1. When the reception processing executor 120 has acquired the missed call data from the reception signals 30, the wireless communication apparatus 1 may cause the display 13 to display a figure representing the missed call. This figure is referred to as a “first missed call figure.”

As described above, in a case where the reception processing executor 120 has acquired the incoming call notification data that is included in the reception signals and directed to the wireless communication apparatus 1, the controller 10 controls the display 13 and the like to notify the user of the call from another mobile phone. If the user does not perform an operation to respond to the notification on the display surface of the display 13, the display 13 displays a figure representing the missed call. This figures is referred to as a “second missed call figure.” The display 13 may display the above-mentioned first missed call figure in a manner different from the second missed call figure. For example, the display 13 may display, as the first missed call figure, a figure different from the second missed call figure.

One of the antennas 110 has a reception sensitivity higher than that of the other antenna 110 in the above-mentioned example. Alternatively, the antennas 110 may have the same reception sensitivity. In this case, the same reception processing executor 20 may intermittently perform the 1× reception processing in the intermittent reception processing regardless of the received signal strength of the 1× signal.

In the intermittent reception processing (high) in the above-mentioned example, while the first reception processing executor 20a performs the 1× reception processing, the second reception processing executor 20b does not perform the LTE reception processing. Alternatively, the second reception processing executor 20b may perform the LTE reception processing.

In the above-mentioned example, while one of the reception processing executors 20 performs the 1× search processing, the other reception processing executor 20 does not perform the LTE reception processing. Alternatively, the other reception processing executor 20 may perform the LTE reception processing.

### <Method for Determining Operation Mode>

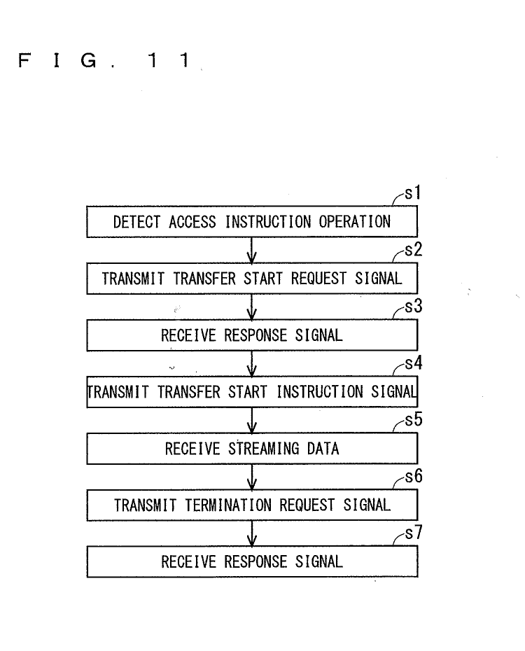

In one embodiment, the reception processing executor 120 operates in an operation mode selected by the user from among the first and second operation modes. When the user performs a predetermined operation on the display surface of the display 13, the controller 10 causes the display 13 to display a selection screen 300 for the user to select the operation mode of the reception processing executor 120. FIG. 10 illustrates an example of the selection screen 300.

As illustrated in FIG. 10, the selection screen 300 includes two buttons, namely a button 301 and a button 302. In a case where the button 301 having the string “call priority” indicated thereon is selected, the first operation mode in which the 1× search processing is executed is selected. In a case where the button 302 having the string “data priority” is selected, meanwhile, the second operation mode in which the 1× search processing is not executed is selected.

In a case where the touch panel 12 has detected an operation performed by the user, with the finger or the like, on the button 301 included in the selection screen 300, the controller 10 determines the first operation mode as the operation mode of the reception processing executor 120. In a case where the touch panel 12 has detected an operation performed by the user, with the finger or the like, on the button 302 included in the selection screen 300, meanwhile, the controller 10 determines the second operation mode as the operation mode of the reception processing executor 120. The reception processing executor 120 performing the intermittent reception processing operates in the operation mode determined by the controller 10.

As described above, the operation mode of the reception processing executor 120 is selected by the user. Thus, in a case where the user gives a higher priority to data communication based on LTE, the user can cause the reception processing executor 120 to operate in the second operation mode. In a case where the user gives a higher priority to voice communication based on 1×, meanwhile, the user can cause the reception processing executor 120 to operate in the first operation mode.

The operation mode of the reception processing executor 120 may be determined in accordance with a different method. The following describes modifications of the method for determining the operation mode of the reception processing executor 120.

### <Various Modifications of Method for Determining Operation Mode>

In one modification, the reception processing executor 120 performing the intermittent reception processing basically operates in the first operation mode in which the 1× search processing is executed. Exceptionally, the reception processing executor 120 operates in the second operation mode in which the 1× search processing is not executed when acquiring a predetermined type of data that is included in the reception signals 30 and is transmitted in accordance with LTE. The predetermined type of data is hereinafter referred to as “specific data.”

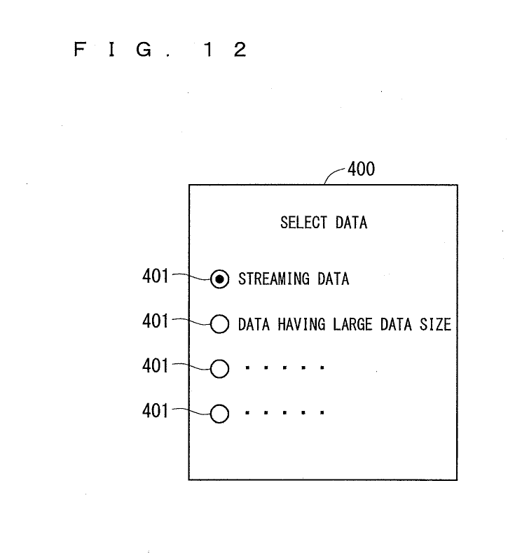

An example of the specific data is the data that does not undergo retransmission control. An example of the data that does not undergo retransmission control is streaming data transmitted through the use of the User Datagram Protocol (UDP). The streaming data transmitted through the use of UDP does not undergo retransmission control. Thus, if the wireless communication apparatus 1 has failed to receive part of the streaming data in an appropriate manner, the part of the data is not retransmitted to the wireless communication apparatus 1. The following describes the operation in which the wireless communication apparatus 1 receives the streaming data transmitted through the use of UDP by the server apparatus 4 connected with the network 3. FIG. 11 illustrates a flowchart showing the operation. The wireless communication apparatus 1 communicates with the server apparatus 4 through the use of the Real Time Streaming Protocol (RTSP).

As illustrated in FIG. 11, in Step s1, the touch panel 12 detects an access instruction operation, such as an operation to input a uniform resource locator (URL), being an instruction to access streaming data stored in the server apparatus 4. Then, in Step s2, the wireless communication apparatus 1 transmits, to the server apparatus 4, a transfer start request signal being a request to start transferring the streaming data. The transfer start request signal is referred to as the “PLAY method” in the RTSP.

Subsequently, in Step s3, the wireless communication apparatus 1 receives a response signal from the server apparatus 4. Then, in Step s4, the wireless communication apparatus 1 transmits, to the server apparatus 4, a transfer start instruction signal being an instruction to start transferring the streaming data. Upon receipt of the transfer start instruction signal, the server apparatus 4 transmits the streaming data through the use of UDP. The streaming data transmitted by the server apparatus 4 is transmitted to the wireless communication apparatus 1 through the base station 2.

In Step s5, the wireless communication apparatus 1 receives, using the antennas 110a and 110b, the streaming data wirelessly transmitted from the base station 2. At that time, the reception processing executor 120 performs the intermittent reception processing to acquire the streaming data included in the reception signals. Furthermore, the reception processing executor 120 operates in the second operation mode. The wireless communication apparatus 1 plays back the received streaming data and displays the streaming data on, for example, the display 13.

In order to terminate communication with the server apparatus 4, in Step s6, the wireless communication apparatus 1 transmits, to the server apparatus 4, a termination request signal being a request to terminate the communication. The termination request signal is referred to as the “TEARDOWN method” in the RTSP. Subsequently, in Step s7, the wireless communication apparatus 1 receives a response signal from the server apparatus 4.

As described above, the reception processing executor 20 operates in the second operation mode when performing the intermittent reception processing to acquire the LTE data that does not undergo retransmission control. The LTE data that does not undergo retransmission control is not retransmitted even if the LTE data has not been acquired by the wireless communication apparatus 1 in an appropriate manner. Thus, after completing the 1× search processing, the reception processing executor 120 cannot acquire the LTE data that has been received by the antenna 110 during execution of the 1× search processing and that does not undergo retransmission control. In one embodiment, the reception processing executor 120 operates in the second operation mode in which the 1× search processing is not performed, thus eliminating or reducing failures to acquire the LTE data that does not undergo retransmission control.

In the above-mentioned example, the specific data is the data that does not undergo retransmission control. Alternatively, the specific data may be other types of data. For example, the specific data may be a file (data) having a data size equal to or greater than the threshold or a file (data) having a data size greater than the threshold. For retransmission control over a file, the reception processing executor 120 operates in the second operation mode in which the 1× search processing is not executed while the wireless communication apparatus 1 receives the data having a large data size. This reduces the time required to acquire (download) the files.

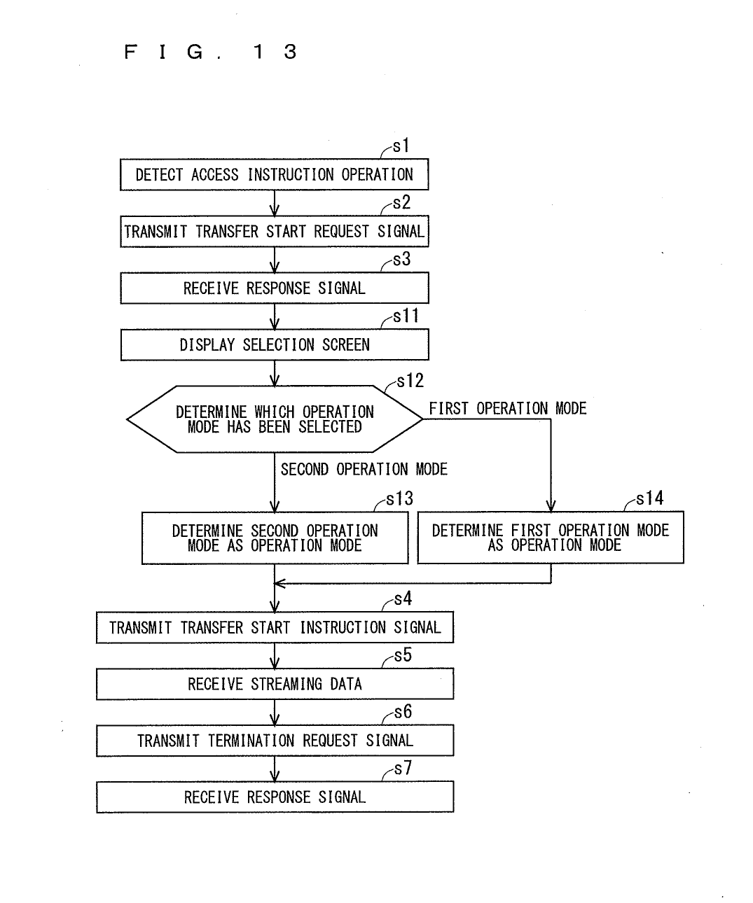

The specific data may be designated by the user. For example, the user can designate the specific data using a predetermined screen displayed on the display surface of the display 13. FIG. 12 illustrates an example of a designation screen 400 for the user to designate the specific data. In one example illustrated in FIG. 12, by using the designation screen 400, the user can designate, as the specific data, streaming data, a file having a data size equal to or greater than the threshold, a file having a data size greater than the threshold, and the like. The user can designate the specific data by selecting, with a finger or the like, any of selection buttons 401 shown in the designation screen 400. In one example illustrated in FIG. 12, streaming data has been designated as the specific data.

The reception processing executor 120 may operate in the operation mode selected by the user in the acquisition of the specific data transmitted in accordance with LTE. FIG. 13 illustrates a flowchart showing the operation of the wireless communication apparatus 1 in this case. Similarly to FIG. 11, FIG. 13 illustrates the operation in which the wireless communication apparatus 1 receives the streaming data transmitted by the server apparatus 4 through the use of UDP.

As illustrated in FIG. 13, the wireless communication apparatus 1 executes Steps s1 to s3 mentioned above. Upon receipt of the response signal in Step s3, the wireless communication apparatus 1 displays, in Step s11, a selection screen for the user to select the operation mode of the reception processing executor 120. For example, the above-mentioned selection screen 300 illustrated in FIG. 10 is displayed.

In a case where the touch panel 12 detects, in Step s12, an operation performed by the user on the button 301 included in the selection screen 300 with a finger or the like, the controller 10 determines the first operation mode as the operation mode of the reception processing executor 120 in Step s13. Meanwhile, in a case where the touch panel 12 detects an operation performed by the user on the button 302 included in the selection screen 300 with a finger or the like, the controller 10 determines the second operation mode as the operation mode of the reception processing executor 120 in Step s14.

Upon execution of Step s13 or Step s14, the wireless communication apparatus 1 executes the above-mentioned Step s4. Subsequently, in Step s5, the wireless communication apparatus 1 receives the streaming data transmitted from the server apparatus 4. At that time, the reception processing executor 20 performing the intermittent reception processing operates in the operation mode selected by the user in Step s12. Subsequent to Step s5, the wireless communication apparatus 1 executes Steps s6 and s7 mentioned above.

In the above-mentioned example, the reception processing executor 120 intermittently executes the 1× reception processing in order to receive paging signals. Alternatively, the reception processing executor 120 may intermittently execute the 1× reception processing in order to receive other signals.

Instead of performing LTE communication, the wireless communication apparatus 1 may perform communication in accordance with another wireless communication scheme. The wireless communication apparatus 1 may perform, instead of LTE communication, communication in accordance with, for example, Wireless Fidelity (WiFi) or World Interoperability for Microwave Access (WiMAX). Instead of performing 1× communication, the wireless communication apparatus 1 may perform communication in accordance with another wireless communication scheme. The wireless communication apparatus 1 may perform, instead of 1× communication, communication in accordance with, for example, Wideband Code Division Multiple Access (W-CDMA).

While the wireless communication apparatus 1 has been described above in detail, the above description is in all aspects illustrative and not restrictive. In addition, various modifications described above are applicable in combination as long as they are not mutually inconsistent. It is understood that numerous modifications which have not been exemplified can be devised without departing from the scope of the present disclosure.

1. A wireless communication apparatus that performs communication in accordance with a first wireless communication scheme and communication in accordance with a second wireless communication scheme,
the wireless communication apparatus comprising:
a first antenna; and
at least one processor that executes a first processing of acquiring first data included in a first reception signal received by the first antenna and a second processing of acquiring second data included in the first reception signal, the first data being transmitted in accordance with the first wireless communication scheme, the second data being transmitted in accordance with the second wireless communication scheme, wherein
the at least one processor performs a reception processing of intermittently executing, while executing the first processing, the second processing in place of the first processing, and
the at least one processor has, as operation modes, a first operation mode and a second operation mode,
the first operation mode being an operation mode in which the at least one processor stops executing the first processing and executes a search processing of searching for a signal transmitted in accordance with the second wireless communication scheme in a case where the at least one processor fails to acquire the second data in the reception processing,
the second operation mode being an operation mode in which the at least one processor continues the reception processing without executing the search processing in a case where the at least one processor fails to acquire the second data in the reception processing.

2. The wireless communication apparatus according to claim 1, wherein:
the at least one processor operates in the second operation mode when acquiring a predetermined type of data that is included in the reception signal and is transmitted in accordance with the first wireless communication scheme.

3. The wireless communication apparatus according to claim 1, wherein:
the at least one processor operates in the operation mode selected by a user.

4. The wireless communication apparatus according to claim 3, further comprising a display that displays a selection screen for the user to select the operation mode.

5. The wireless communication apparatus according to claim 4, wherein:
the display displays the selection screen when the at least one processor acquires a predetermined type of data that is included in the reception signal and is transmitted in accordance with the first wireless communication scheme.

6. The wireless communication apparatus according to claim 2, wherein:
the predetermined type of data comprises data that does not undergo retransmission control.

7. The wireless communication apparatus according to claim 5, wherein:
the predetermined type of data comprises data that does not undergo retransmission control.

8. The wireless communication apparatus according to claim 2, wherein:
the predetermined type of data comprises data having a data size equal to or greater than a threshold or data having a data size greater than the threshold.

9. The wireless communication apparatus according to claim 5, wherein:
the predetermined type of data comprises data having a data size equal to or greater than a threshold or data having a data size greater than the threshold.

10. The wireless communication apparatus according to claim 2, wherein:
the predetermined type of data is designated by a user.

11. The wireless communication apparatus according to claim 5, wherein:
the predetermined type of data is designated by the user.

12. The wireless communication apparatus according to claim 1, wherein:
the at least one processor resumes the reception processing after completing the search processing.

13. The wireless communication apparatus according to claim 1, further comprising a second antenna, wherein:
the at least one processor executes a third processing of acquiring third data that is included in a second reception signal received by the second antenna and is transmitted in accordance with the first wireless communication scheme, and
when performing the reception processing, the at least one processor executes the third processing while executing the first processing and does not execute the third processing while executing the search processing.

14. A wireless communication method comprising:
stopping a first processing and executing a search processing of searching for a signal transmitted in accordance with a second wireless communication scheme in a case where a reception processing fails to acquire second data, the reception processing intermittently executing, while executing the first processing, a second processing in place of the first processing, the first processing acquiring first data that is included in a reception signal transmitted in accordance with a first wireless communication scheme, the second processing acquiring the second data that is included in the reception signal and is transmitted in accordance with the second wireless communication scheme; and
continuing the reception processing without executing the search processing in a case where the reception processing fails to acquire the second data.
